(19) United States
(12) Patent Application Publication
(10) Pub. No.: US 2011/0017123 A1
(43) Pub. Date: Jan. 27, 2011

(54) RESIDUAL LIFETIME INDICATOR FOR PERISHABLE CONSUMER PRODUCTS

(76) Inventors: Marco Maschietti, Roma (IT); Marco Bianchini, Roma (IT)

Correspondence Address: Steinfl & Bruno, 301 N Lake Ave Ste 810, Pasadena, CA, 91101, US

(21) Appl. No.: 12/922,452

(22) PCT Filed: Apr. 9, 2009
(86) PCT No.: PCT/EP2009/002630

§ 371 Date: Sep. 13, 2010

(30) Foreign Application Priority Data
Apr. 11, 2008 (IT) GE2008A000027

(51) Int. Cl. G01K 1/02

(52) U.S. Cl. 116/216

(57) ABSTRACT

Residual lifetime indicator device for perishable consumer products, comprising a material having a property which can change as temperature changes according to a given function, actuating means (102, 104, 204; 10) which act on said material to make it show the aforesaid property, and indicating means (105; 308) coupled to the material/actuating means combination, said indicating means indicating the residual lifetime in relation to the expiry date of the product, said material being a fluid with a viscosity which can change depending on temperature, which fluid flows into a pipe having a given section, characterized in that the actuating means comprise an element to apply a pressure differential to said fluid (102, 104, 204; 10), the flow of said fluid being connected to said indicating means (105; 308), activating means (604; 14) to activate said element being provided to apply a pressure differential to said fluid (102, 104, 204; 10).

The present invention relates to systems for assessing the influence of variations in temperature on perishable products, and particularly relates to a residual lifetime indicator device for consumer products, in particular for food products.

Most industrial products, and particularly the products of the food and agricultural or pharmaceutical industry, have properties which deteriorate, until they reach zero, within a given time period, which is generally shown as the validity or expiry date of the product. It should however be stated that generally, as is often reported on the packs of the said products, this date refers to the intact product stored in an optimal manner; however, it is not always possible for the consumer to establish whether the product has been stored in the most appropriate way before being purchased.

From document U.S. Pat. No. 5,531,180, a device is known which is able to record the temperature variation which a product, in particular a deep frozen product, has undergone, and to indicate its extent by suitable means. However, this device does not provide any assessment as to the actual residual life of the product, and thus the information it records is difficult to be communicated to the consumer, who normally has neither the knowledge nor the technical means to carry out this kind of assessments.

In WO-A-99/44021, a time-temperature indicator is described wherein a small bar of a given material is subjected to a traction load, for example from a spring, and the given material is able to vary its response to the traction depending on temperature. In this way, by appropriately selecting the stretchable material and the means for subjecting it to a traction load, it is possible to obtain a device which provides information concerning the residual lifetime of the product to which said device has been linked. However, with regard to practical application, this type of solution shows a series of difficulties connected mainly with the selection of the subject materials; first, considerable difficulties in calibrating the indicator may also arise. Moreover, many of these can come out to be toxic or in any case harmful, and this fact is poorly suitable to a device intended for use on food or pharmaceutical products. Finally, this device exhibits substantial complications in order to obtain an irreversible indication of the residual lifetime of the product.

Patent Application WO-A-2006/128746, filed in the name of the same Applicant, discloses a residual lifetime indicator device for perishable consumer products, comprising a material which displays a property variable with variation of the temperature according to a given function, actuating means which act on the said material so as to make it exhibit the aforesaid property, and indicator means linked to the material/actuating means combination, said indicator means indicating the residual lifetime with respect to the expiry date of the product; said material is a fluid of viscosity varying as a function of the temperature, which flows in a pipe of a given cross-section, the actuating means comprising a device capable of applying an essentially constant pressure onto said fluid, the flow of said fluid being linked to said indicator means.

In particular, said element capable of applying a constant pressure to said fluid can comprise an osmotic solvent/solution couple separated by a semi-permeable membrane and connected, via two mobile means of separation located at its ends, to the two ends of the pipe in which the fluid of variable viscosity is located.

This device solves many of the problems encountered with the systems known in the art, but it still has some inconveniences. Particularly, there is disclosed no way of actuating the indicator in a time different from that of the manufacture thereof, and this could force to mount such indicator when goods to be monitored are stored. Moreover, although the embodiment described in the patent application, i.e. the embodiment using the osmotic couple as an element to apply a constant pressure to the viscous fluid, has several advantages, it is still quite complex from the manufacturing viewpoint.

Thus, an aim of the present invention is to provide a residual lifetime indicator device for perishable consumer products which, besides having the above-listed advantageous features, can be manufactured and used in two distinct times without compromising the operational effectiveness thereof.

Another aim of the present invention is to provide an indicator device of the above-described kind, which can be manufactured in an extremely simple way while maximally reducing the variables which have to be controlled to achieve a reliable result.

Therefore, the object of the present invention is a residual lifetime indicator device for perishable consumer products, comprising a material having a property which can change as temperature changes according to a given function, actuating means which act on said material to make it show the aforesaid property, and indicating means coupled to the material/actuating means combination, said indicating means indicating the residual lifetime in relation to the actual expiry date of the product, said material being a fluid with a viscosity which can change depending on temperature, which fluid flows into a pipe having a given section, the actuating means comprising an element to apply a pressure differential to said fluid, the flow of said fluid being connected to said indicating means; furthermore, means for activating said element are provided to apply a pressure differential to said fluid, so as to differentiate between the manufacturing stage and the operating stage of said device.

In an embodiment, said element to apply a pressure differential to said fluid can comprise an osmotic solvent/solution couple separated by a semi-permeable membrane, and said activating means comprise removable means to manage the generation of said pressure differential to said fluid.

Particularly, said means to manage the generation of said pressure differential can comprise a removable barrier arranged between a chamber containing a solution of increased concentration and a chamber containing a solution of increased dilution; in fact, the osmotic couple establishing the pressure differential applied to said viscous fluid will be created by removing said barrier.

Alternatively, said means to manage the generation of said pressure differential comprise a compensating chamber to compensate the pressure differential applied by said element, which compensating chamber is arranged at the opposite end of said pipe in which said fluid flows with respect to the element itself.

In a further embodiment, said element to apply a pressure differential to said fluid comprises a chamber containing a gaseous fluid at a given pressure.

Advantageously, the viscous fluid is a polyolefin and particularly polyisobutene, with a molecular weight ranging from 320 to 1,400, and preferably with a molecular weight of 920.

Further advantages and features will be apparent from the following detailed description of some embodiments of the device according to the present invention, which are set out by way of illustration, and not by way of limitation, with reference to the accompanying drawings wherein:

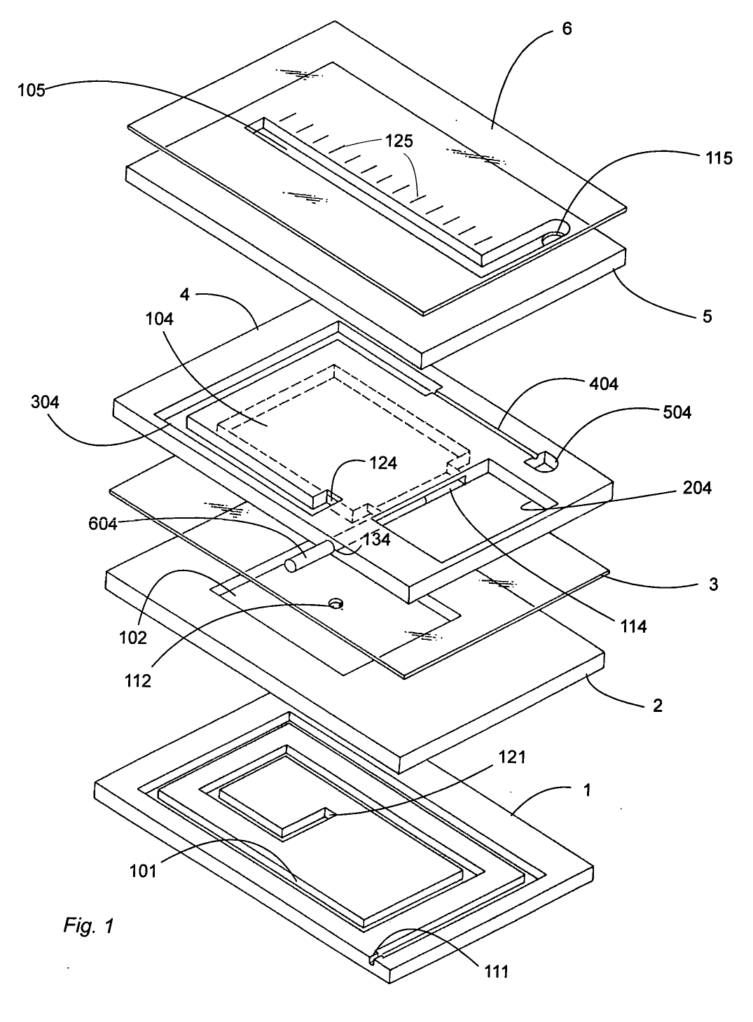

FIG. 1 is an exploded perspective view of a first embodiment of the device according to the present invention;

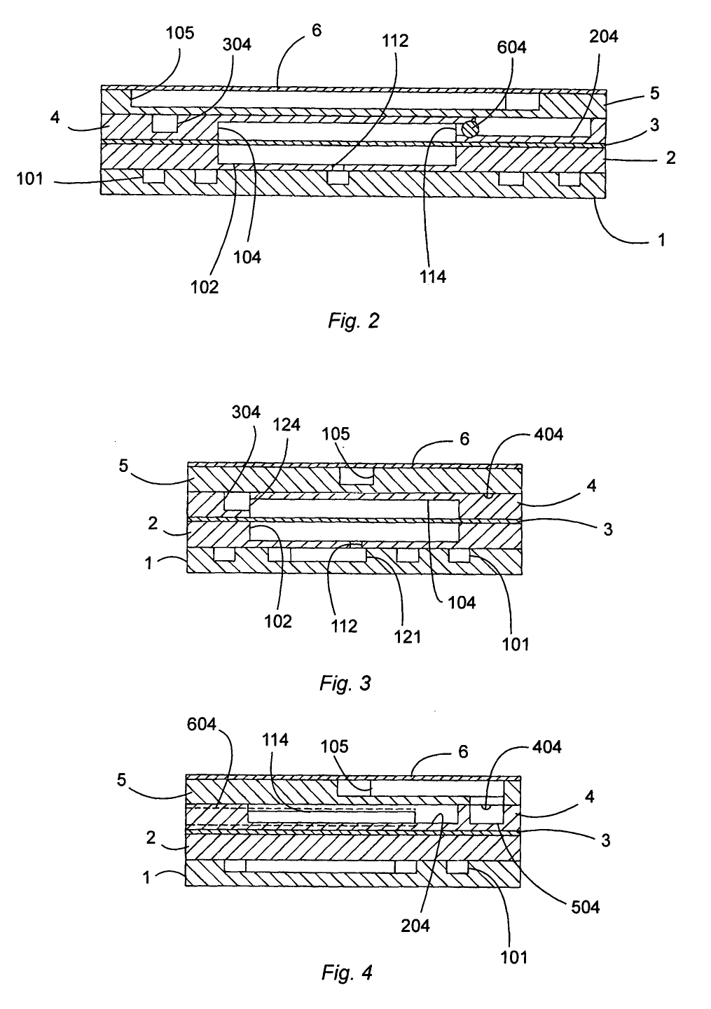

FIG. 2 is a longitudinal section view of the device in FIG. 1;

FIG. 3 is a cross-sectioned view of the device in FIG. 1;

FIG. 4 is another cross-sectioned view of the device in FIG. 1;

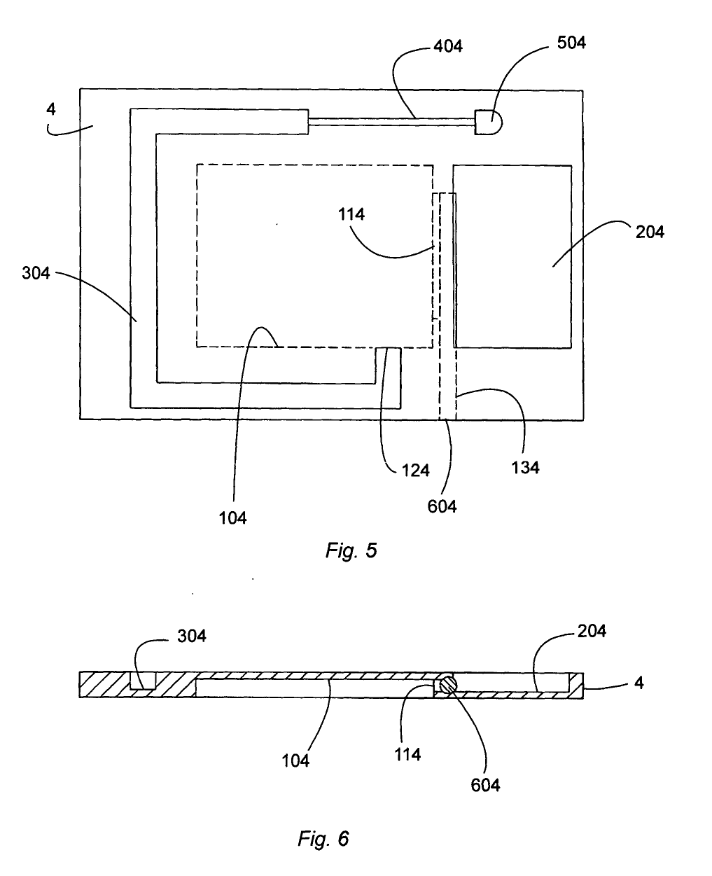

FIG. 5 is a top plan view of an element of the device in FIG. 1;

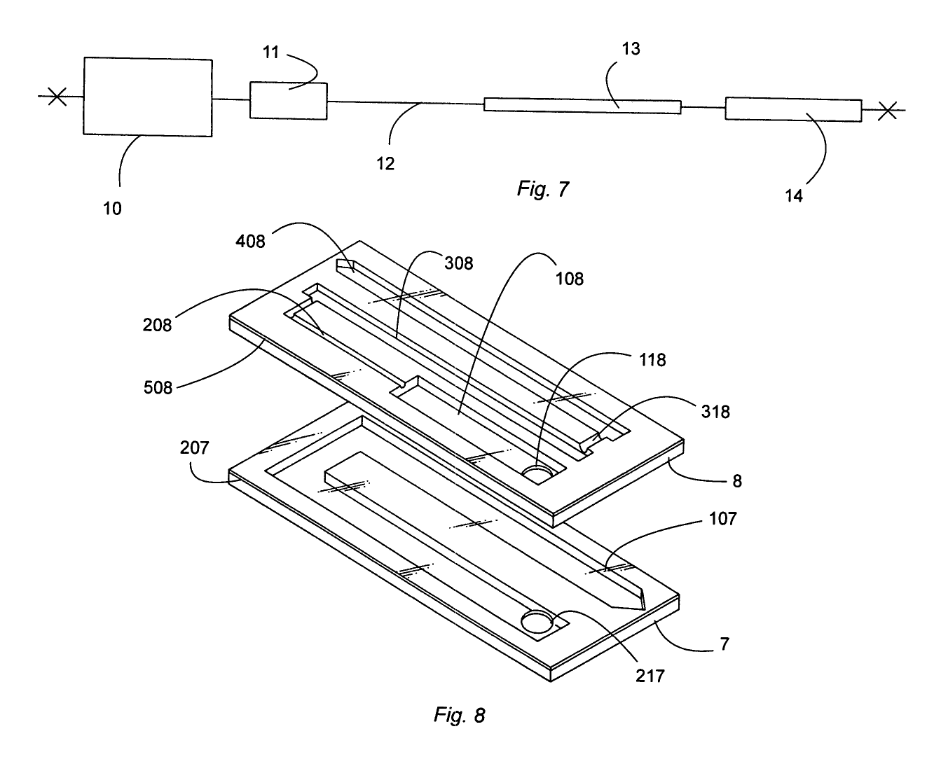

FIG. 6 is a sectional view taken along line VI-VI of FIG. 5;

FIG. 7 is a schematic diagram showing a second embodiment of the device according to the present invention;

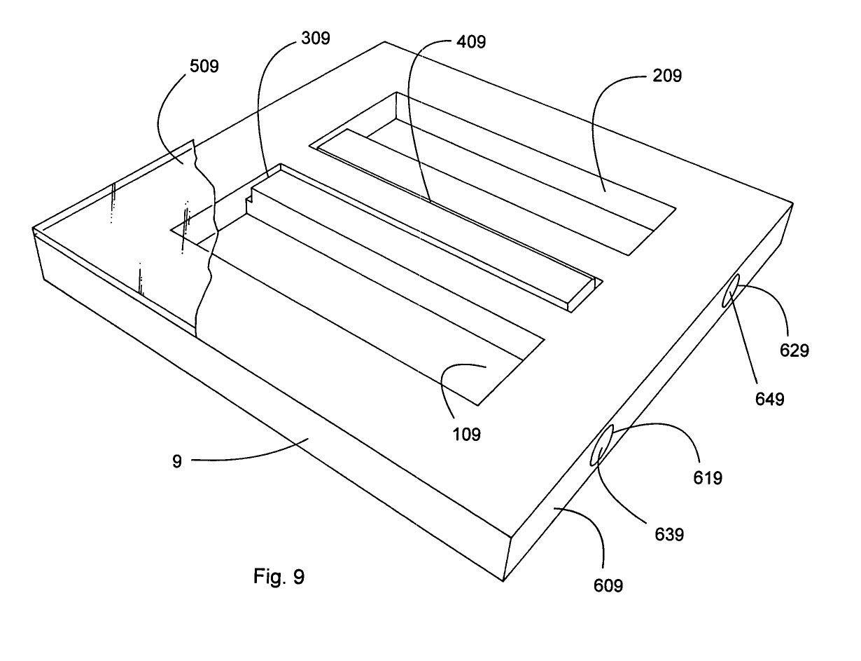

FIG. 8 is an exploded perspective view of a second embodiment of the device according to the invention;

FIG. 9 is a perspective view of a further embodiment of the device according to the present invention;

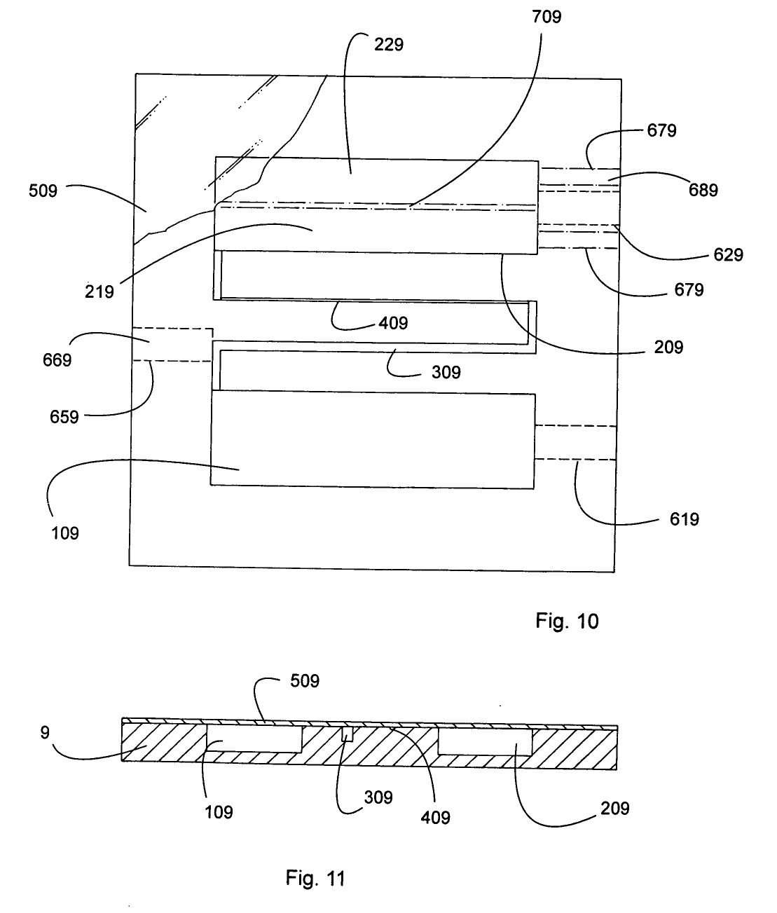

FIG. 10 is a top plan view of the device of the FIG. 9; and

FIG. 11 is a sectional view taken along the line XI-XI of the FIG. 10.

FIG. 1 illustrates a first embodiment of the indicator device according to the present invention; reference numeral 1 denotes the basic layer of a multilayer structure. Said basic layer 1 has a wrap-around channel 101 communicating with the outside through the opening 111 at an end, and with a through-hole 112 at the opposite end 121, said through-hole being drilled in the bottom wall of a chamber 102 formed in the second layer 2. Said layer has arranged thereon an osmotic semi-permeable membrane 3 which separates said chamber 102 from a chamber 104 formed in the bottom face of a layer 4; said chamber communicates with another chamber 204 through a large side passage 114, said another chamber being formed in the upper face of said layer 4. The chambers 104 and 204 are separated from each other by the removable pin 604 which is inserted in the channel 134 communicating with the opening 114. The chamber 104 also communicates with the pipe 304 through the opening 124; said pipe communicates with the capillary 404 which flows into the sump 504 at the opposite end thereof. Said sump 504 is in communication with the L-shaped channel 105 formed in the upper face of the layer 5 by way of the through-hole 115; the major arm of the channel 105 has graduation marks 125 which provide the appropriate indication through the transparent covering layer 6.

FIG. 2 illustrates a longitudinal section of the device in FIG. 1; like reference numerals refer to like elements. FIG. 2 shows much more clearly the arrangements of the chambers 102, 104 and 204 as well as the position of the pin 603 acting as a separating barrier within the communication opening 114 between the chamber 104 and the chamber 204. In FIG. 3, which shows a cross-section of the device in FIG. 1, both the communication between the end 121 of the channel 101 of the layer 1 and the hole 112 in the bottom of the chamber 102, and the communication between the chamber 104 and the channel 304 through the opening 124 are clearly evident; the capillary 404 is also shown. In the cross-section of FIG. 4 there is again shown the position of the pin 604 to intercept the void of the opening 114, and there is also shown the communication between the capillary 404 and the sump 504 which, in turn, communicates with the channel 105 of the layer 5 by way of the through-hole 115.

FIG. 5 illustrates a plan view of the layer 4 of the device in FIG. 1; like reference numerals refer to like elements; the section of FIG. 6 shows in more detail the construction of the layer itself, with the chambers 104 and 204 being formed in opposite faces of the layer 4 itself.

FIG. 7 illustrates a schematic diagram relating to a second embodiment of the device according to the present invention; reference numeral 10 denotes a reservoir containing a pressurized gaseous fluid in communication with a volume 11 of a viscous fluid, which communicates with the indicating means 13 through the capillary pipe 12, said indicating means 13 being connected to a compensating chamber 14 which also contains a pressurized gaseous fluid.

In FIG. 8 there is shown a perspective view of an implementation of the embodiment as schematically illustrated in FIG. 7; the basic layer 7 has a chamber 107 cut in the thickness thereof and coated with a film 207 in which a through-hole 217 is formed. The aforesaid hole 217 places the chamber 207 in communication with the chamber 108 of the layer 8, whose bottom wall has formed thereon the through-hole 118; the chamber communicates with the channel 308 through the capillary pipe 208, and the channel 308 itself is in communication with the compensating chamber 408 through the pipe 318. The whole layer 8 is covered by the protective film 508.

In FIG. 9 is shown another embodiment of the device according to the present invention. A single layer of material, preferably plastic material, forms the base 9, in which two chambers 109 and 209 are formed, communicating one with the other. The communication is provided by a channel 309 and a capillary conduit 409. The device comprise a layer of transparent material 509, acting as a cover. On the side walls 609 of the base 9 are provided two openings 619, 629, on which a closing means 629, 649 are placed, respectively.

In FIG. 10 the device according to the embodiment on FIG. 9 in shown in top plane view; the same numeral indicates the same part of the device. As it could be noted in the drawing, the openings 619, 629 communicate with the respective chamber 109, 209. More over, another opening 659 is formed in the side wall 609, near the channel 309, also provided with closing means 669. With the dotted line is indicated the barrier 709, which could be positioned so as to divide the chamber 209 in two compartments 219, 229; both the compartments are provided with an opening 679 and closing means 689. In FIG. 11 is shown a sectional view along the line XI-XI of the FIG. 10; in the figure is highlighted the simple and effective structure of the device according to this embodiment.

The operation of the device according to the present invention will become apparent from the following. With reference to the first embodiment illustrated in FIGS. 1 to 6, the device of the invention has an element which applies a pressure differential to the viscous fluid which flows into the capillary pipe 404, comprising an osmotic couple consisting of a solvent such as water, for example, and a saline solution; when the device is manufactured, the solvent, i.e. water, is contained in the chambers 102 and 104, which communicate with each other through the semi-permeable membrane 3. According to the illustrated embodiment, it is preferable to use a reverse osmosis semi-permeable membrane with an osmotic couple consisting of saline aqueous solutions at different concentrations (one of the two liquids can even be pure water); alternatively, it is possible to use a reverse osmosis-semipermeable membrane with an osmotic couple comprising aqueous solutions of glucose at different concentrations (one of the two liquids can even be pure water). Another option can be a reverse osmosis- or nanofiltration-semipermeable membrane with an osmotic couple comprising aqueous solutions of sucrose or polysaccharides at different concentrations (one of the two liquids can even be pure water).

Obviously, until the concentrations throughout the membrane are identical, no pressure is applied to the viscous fluid which is in the pipe 304 of the layer 4. Instead, the chamber 204 of the same layer accommodates a highly concentrated saline solution, and when the pin 604 occluding the opening 114 is removed, than such highly concentrated saline solution can be passed through the opening 114 and mixed with the solvent contained in the chamber 104. Now, when the solution is contained in the two chambers 104 and 204 with the solvent in the chamber 102, there is formed the osmotic couple which generates the pressure differential to make the viscous liquid flow into the capillary pipe 404. In contrast with the application of a substantially constant pressure as defined in the patent application previously filed by the same Applicant, by using a simple pressure differential which per se could even be non-constant, it is possible to take into account the fact that it is quite simpler to evaluate a certain law of variation for the applied pressure than to keep the pressure constant over the entire operative lifetime of the device.

As for the remainder, the behaviour of the viscous fluid subjected to the so-created pressure differential is substantially as described in patent application WO-A-2006/128746. In particular, the viscous fluid having the most suitable features for use with the device of the invention is polyisobutene, which is an oligomer of isobutene, and particularly preferred are the molecular weights ranging from 320 to 1,400, and preferably the molecular weight of 920 with a pour point of −7° C. It is a highly viscous liquid having a viscosity which can greatly change depending on temperature; it is completely immiscible with water and saline aqueous solutions. Lower molecular weights have pour points as low as −50° C., while higher molecular weights have pour points as high as 10° C.; by using the appropriate molecular weight it is possible to cover a wide range of applications.

Compared to the device known from the previously mentioned patent in the name of the same Applicant, the so-conceived device has the advantage to allow for a delayed use of the device itself with respect to the manufacture time thereof; indeed, the device is produced with the pin effectively separating the concentrated saline solution from the solvent which is contained in the chamber 104, without any pressure applied to the viscous fluid until the opening 114 is cleared.

During the research which led to the development of the present invention, the inventors have evaluated the opportunity of an element which was structurally and constructively quite simpler than the previously described osmotic couple to apply the pressure differential to said fluid. In this case, it has been investigated the possibility to manufacture the device according to the alternative embodiments illustrated in the FIGS. 7 and 8. In practice, the pressure differential is generated by a reservoir, i.e. a chamber which is formed in one of the layers of the device as illustrated in FIG. 8, into which a pressurized gaseous fluid is input to apply a pressure onto the viscous fluid. Another amount of pressurized gaseous fluid will be loaded at the opposite end of the pipe to balance the pressure applied by the fluid contained in the reservoir, so that the system is balanced until the structure of the compensating chamber 408 is kept as a whole. In order to actuate the device, it is sufficient to make a hole in the walls of the compensating chamber 408 to make it reach ambient pressure. This operation will result in establishing the pressure differential onto the viscous fluid, and the position of the indicating means will be accordingly varied. The indicator is disposed in the channel 308 and it can comprise the same viscous fluid which is appropriately coloured, as well as an aqueous solution containing an appropriate dyer.

Obviously, the pressure applied to the gaseous fluid in the reservoir formed in the chamber 107 will be about a few tenths of an atmosphere more than the atmospheric pressure. The pressure of the gas, the amount to be input into the chamber 107, and the volume of the compensating chamber 408 are related to each other by the ideal gas equation of state:

PV=nRT

where T is the temperature in K. Small temperature changes around the nominal temperature for the operation of the indicator will result in slight pressure changes in the system just because the temperature scale in the equation of state is in K.

Eventually, this effect has a very small influence on the travel speed which is mostly controlled by the viscosity of the fluid. And however, the heat effect is added to and not subtracted from the viscous effect: higher temperatures will result in a lower viscosity and a slightly greater pushing pressure; vice versa at lower temperatures.

The relation between the pressure existing in chamber 107 and the travel speed of the viscous fluid is given by the Poiseuille's law for laminar flow in cylindrical pipes. The pressure drop encountered by the fluid is just the pressure P of the gas contained in chamber 107, minus the ambient pressure:

ΔP=P_{gas}−P_{ambient}

The travel speed of the viscous fluid is given by the Poiseuille's law:

$$Δ P = \frac{8 μ L}{π {r}_{C}^{4}} \cdot Q$$

where μ is the viscosity (the component which highly changes according to temperature) of the fluid, L is the length of the capillary, r_{C} is the radius of the capillary, and Q is the output flow rate. In turn, the output flow rate depends on the radius (r_{I}) of the channel of the indicator according to:

Q=πr_{I}²v

Ultimately, the travel speed of the fluid in the pipe is:

$$v = \frac{{r}_{C}^{4} Δ P}{8 {r}_{I}^{2} μ L}$$

This relationship clearly shows that the response of the indicator can be calibrated according to many parameters: length and radius of the capillary, radius of the channel of the indicator, viscosity of the chosen fluid, charge pressure of the gas in the chamber acting as a reservoir.

It should be noted that this indicator can also operate at temperatures lower than 0° C. since, in this case, the element applying the pressure gradient doesn't comprise a water-based osmotic couple; therefore, it is suitable to applications in the field of frozen foods, and not only in the field of refrigerated foods (at about 4° C.). The lower end of the operating temperature is determined by the pour point of the viscous fluid as well as the freezing point of the indicator fluid, which cannot necessarily comprise coloured water and the like if the temperature is lowered substantially below 0° C.

Moreover, in both the above-described embodiments of the device according to the present invention, the pressure differential applied to the viscous fluid is positive, i.e. the viscous fluid itself is pushed towards the indicating means through the capillary pipe. In principle, it is absolutely possible to manufacture the device according to the present invention by applying a negative pressure differential, i.e. by operating at under pressure with respect to the viscous fluid. If an osmotic solvent/solution couple is used, such result can be obtained by simply inverting the position of the chambers containing the solvent and the solution with respect to the viscous fluid. However, from a practical viewpoint, this kind of solution has some manufacturing difficulties, mainly because air bubbles could occur within the solvent and they could compromise the proper operation of the device.

On the contrary, in the embodiment illustrated in FIGS. 7 and 8, replacing a gaseous fluid at a pressure higher than atmospheric pressure with a vacuum of a few percent of an atmosphere is very less troublesome. In this case, the operation of the device is just as described above, except that the flow direction of the viscous fluid is inverted. This approach simplifies the manufacture of the multilayer device illustrated in FIG. 8, since the attachment of the different layers while applying a vacuum would be made even more effective.

Furthermore, it should be reminded that the actuating system used in the embodiment illustrated in FIGS. 7 and 8, i.e. the system involving the use of a compensating chamber, can also be suitably used to actuate the device which utilizes an osmotic solvent/solution couple as an element to apply the pressure differential; indeed, in this case, because of the presence of a pressurized gaseous fluid at the end of the flow circuit to receive the pressure generated by said element, it is likewise possible to establish the balance which can be broken only by bringing said fluid to ambient pressure.

In the embodiment illustrated in the FIGS. 9 to 11, the basic principle which has been developed is quite similar to that as referred to above for the embodiment of the FIGS. 7 and 8. Moreover, the construction of this embodiments has the appearing advantage of the use of a single layer of material in which both the chambers 109, 209 are formed. This solution allows the production of a very thin device, which could be conveniently used in a broad number of applications. The device could be produced by direct molding of the layer 9, which could be made of thermoplastic material or the like. Particularly, the capillary conduit could be realized independently from the said layer and then inserted therein, or alternatively it could be formed by using laser or etching technologies.

As shown in the FIG. 9, the device is provided with a chamber 109, in which is introduced a gas having an higher pressure P_{H} and with a chamber 209, in which the gas introduced has a lower pressure P_{L}. Since the viscous liquid is positioned in the channel 309 and the capillary conduit 409, the difference of pressure ΔP=P_{H}−P_{L} is able to make the liquid moving along the said capillary conduit.

In any case the travel speed of the viscous fluid will be:

$$v = \frac{1}{{S}_{I}} \cdot \frac{π {r}_{C}^{4}}{8 μ {L}_{C}} \cdot Δ P$$

Where S_{I} is the section of the channel in which the viscous liquid is introduced, r_{C} and L_{C} are respectively the radius and the length of the capillary conduit, and μ is the viscosity of the liquid.

The device could be stored at a temperature lower than −10° C., and preferably at a temperature lower than −20° C., so as prevent the flow of the liquid and therefore the activation of the device. Alternatively, both the chambers could be charged with a gas at the same pressure, and the activation could be performed by the removal of the closing means of one of the chambers, so as to put the gas inside the chamber at the atmospheric pressure.

Another solution for the activation of this embodiment of the device according to the present invention is shown in FIG. 10; the barrier 709 divides the chamber 209 in two compartments 219 and 229. The compartment 219 is filled with a gas having the same pressure P_{H} as the chamber 109. In the compartment 229 is charged a gas having a pressure P_{LL} which is sensibly lower than the pressure P_{H}. By this way, the device can be stored without any pushing force acting on the viscous liquid; when the barrier 709 is broken, the pressure in the chamber 209 reach the pressure P_{L} and the liquid will begin to move along the indicating path. This kind of solution shows the clear advantage of preventing any communication of the device with the environment, which could adversely affect its operation.

1. A residual lifetime indicator device for perishable consumer products, comprising
a material having a property which can change as temperature changes according to a given function,
actuating means which are adapted to act on said material to have said material exhibit said property, and
indicating means coupled to the material/actuating means combination, said indicating means indicating the residual lifetime in relation to an actual expiry date of the product, said material being a fluid with a viscosity which can change depending on temperature, which fluid flows into a pipe having a given section,
wherein the actuating means comprise an element to apply a pressure differential to said fluid, the flow of said fluid being connected to said indicating means, the device further comprising activating means to activate said element to apply a pressure differential to said fluid.

2. The device according to claim 1, wherein said activating means comprise removable means to manage generation of said pressure differential applied to said fluid.

3. The device according to claim 1, wherein said element to apply a pressure differential to said fluid comprises an osmotic solvent/solution couple separated by a semi-permeable membrane.

4. The device according to claim 1, wherein said element to apply a pressure differential to said fluid comprises a chamber containing a gaseous fluid at a given pressure.

5. The device according to claim 10, wherein said means to manage the generation of said pressure differential comprise a removable barrier which is arranged between a first chamber containing a solution of increased concentration and a second chamber containing a solution of increased dilution.

6. The device according to claim 2, wherein said means to manage the generation of said pressure differential comprise a compensating chamber to compensate the pressure differential applied by said element, said compensating chamber being arranged at an opposite end of said pipe in which said fluid flows with respect to the element itself.

7. The device according to claim 1, wherein the variable viscosity fluid is a polyolefin.

8. The device according to claim 7, wherein said variable viscosity fluid is polyisobutene.

9. The device according to claim 8, wherein said variable viscosity fluid is polyisobutene having a molecular weight ranging from 700 to 1,200, and preferably a molecular weight of 920.

10. The device according to claim 2, wherein said element to apply a pressure differential to said fluid comprises an osmotic solvent/solution couple separated by a semi-permeable membrane.
